(19) United States
(12) Patent Application Publication
(10) Pub. No.: US 2014/0279173 A1
(43) Pub. Date: Sep. 18, 2014

(54) ONLINE REAL ESTATE RENTAL OFFER SYSTEM AND METHOD

(71) Applicant: ZUMPER, INC., San Francisco, CA (US)

(72) Inventor: Anthemos P. Georgiades, San Francisco, CA (US)

(73) Assignee: ZUMPER, INC., San Francisco, CA (US)

(21) Appl. No.: 14/206,927

(22) Filed: Mar. 12, 2014

Related U.S. Application Data
(60) Provisional application No. 61/777,559, filed on Mar. 12, 2013.

(51) Int. Cl. G06Q 50/16; G06Q 30/06

(52) U.S. Cl. CPC G06Q 50/16; G06Q 30/0611; G06Q 30/0645
USPC 705/26.4

(57) ABSTRACT

An online real estate rental offer system provides prospective tenants with transparent pricing and other information for a particular rental unit. The system allows prospective tenants to adjust their rent offers in response to offers made by other prospective tenants.

### CROSS REFERENCE TO RELATED APPLICATION

This application claims priority from U.S. Provisional Patent Application No. 61/777,559 filed on Mar. 12, 2013 entitled ONLINE REAL ESTATE RENTAL OFFER SYSTEM, which is hereby incorporated by reference.

### BACKGROUND

Real estate rental lease transactions are typically conducted as follows. A landlord, broker, or property manager for a particular real estate rental unit (e.g., an apartment or house) advertises a listing for the unit on various real estate sites (e.g., Trulia.com, Zillow.com, Craigslist.org, and Zumper.com), which display photographs and information on the listing. Renters interested in the rental unit visit the unit either during an open house when multiple prospective tenants visit at the same time or in a privately scheduled appointment. Renters wanting to make an offer on the unit will, in most cases, be asked to fill out a confidential paper application with their details and financial profile, with the ‘monthly rent’ being a fixed standard field. Less frequently, prospective tenants are asked to fill out the same form in digital format.

Various online services are available that allow real estate professionals to conduct a credit check on prospective tenants and/or to enable a prospective tenant to sign a lease online (e.g., www.On-Site.com, www.docusign.com, www.rentalpro.zillow.com, www.rocketlease.com). However, for the most part, rental deals in real estate today are conducted offline.

### BRIEF SUMMARY OF THE DISCLOSURE

In accordance with one or more embodiments, a computer implemented method is provided for conducting real estate rental transactions. The method features (a) providing on a server computer system an online listing for a real estate rental, said online listing being accessible by client devices operated by prospective tenants over a communications network, said online listing providing information on a real estate property to be rented; (b) receiving, at the server computer system, an offer and a rental application for the real estate rental from each of a plurality of prospective tenants, each offer indicating a rent amount the prospective tenant is willing to pay for the real estate rental; (c) providing a live online offer board for the real estate rental on the server computer system accessible by the client devices operated by the prospective tenants, said live online offer board displaying the rent amount of each offer received for the rental property or the total number of offers received for the rental property, said live online offer board being dynamically updated with each new offer received by the server computer system from prospective tenants; (d) selecting a prospective tenant whose offer is to be accepted from the plurality of prospective tenants based at least in part on the offer and the rental application of the prospective tenant; and (e) notifying the prospective tenant whose offer is to be accepted.

In accordance with one or more embodiments, a computer system is provided comprising at least one processor, memory associated with the at least one processor, and a program supported in the memory for conducting real estate rental transactions. The program contains a plurality of instructions which, when executed by the at least one processor, cause the at least one processor to: (a) provide an online listing for a real estate rental, said online listing being accessible by client devices operated by prospective tenants over a communications network, said online listing providing information on a real estate property to be rented; (b) receive an offer and a rental application for the real estate rental from each of a plurality of prospective tenants, each offer indicating a rent amount the prospective tenant is willing to pay for the real estate rental; and (c) provide a live online offer board for the real estate rental accessible by the client devices operated by the prospective tenants, said live online offer board displaying the rent amount of each offer received for the rental property or the total number of offers received for the rental property, said live online offer board being dynamically updated with each new offer received by the server computer system from prospective tenants.

### BRIEF DESCRIPTION OF THE DRAWINGS

FIG. 1 is a block diagram illustrating a representative network in which a real estate rental offer system in accordance with one or more embodiments can be implemented.

FIG. 2 is a screenshot illustrating one example of an Offer Board page accessible by prospective tenants in accordance with one or more embodiments.

FIG. 3 is a screenshot illustrating one example of a webpage on which a renter can create a profile and make an offer for a rental unit in accordance with one or more embodiments.

FIG. 4 is a screenshot illustrating one example of an Offer Board dashboard accessible by real estate professionals in accordance with one or more embodiments.

FIG. 5 is a flowchart illustrating an exemplary process flow involving use of the real estate rental offer system by a prospective tenant.

FIG. 6 is a flowchart illustrating an exemplary process flow involving use of the real estate rental offer system by a real estate professional.

### DETAILED DESCRIPTION

Various embodiments disclosed herein are directed to an online real estate rental offer system. In one or more embodiments, the system provides prospective tenants with transparent pricing and other information for a particular rental unit, and allows tenants to adjust their rent offers in response to offers made by other prospective tenants. The transparent pricing information for a particular rental unit includes information on the number of other offers (if any) that have been made (in some embodiments) and also the price of each offer (in other embodiments).

FIG. 1 illustrates an exemplary network, in which a real estate rental offer system 100 in accordance with one or more embodiments can be implemented. The real estate rental offer system 100 is preferably implemented in a computer server system, which communicates with a plurality of client devices operated by the users of the system 100, including prospective tenants 102 and real estate professionals 104. The client devices communicate with the system 100 over a communications network 106. The communications network 106 may comprise any network or combination of networks including, without limitation, the Internet, a local area network, a wide area network, a wireless network, and a cellular network.

The client devices operated by users to access the system 100 can comprise any computing device that can communicate with the computer server system including, without limitation, personal computers (including desktop, notebook, and tablet computers), smart phones and other smart devices, and cell phones. A representative client device includes at least one computer processor and a storage medium readable by the processor for storing applications and data. The client device also includes input/output devices such as one or more speakers for acoustic output, a microphone for acoustic input, and a display for visual output, e.g., an LCD or LED display, which may optionally have touch screen input capabilities.

The client devices can access the real estate rental offer system through a web browser. Alternately, the client devices (especially smart phones and tablets) can access the system through a native mobile app stored on the device.

The term “real estate professional” as used herein refers to the party managing the rental transaction with the tenant. Real estate professionals can include, e.g., landlords, brokers, and property managers.

FIG. 5 illustrates an exemplary process flow involving use of the system 100 by a prospective tenant.

1. The prospective tenant identifies a desired rental unit from one of a number of possible rental information sources including, e.g., marketing websites such as Craigslist at 500.

2. The prospective tenant visits the unit either during an open house or in a private appointment at 502.

3. The real estate professional handling the renting of the unit asks the prospective tenant to submit his or her offer and application to the rental system online at 504.

4. The prospective tenant accesses the rental system website and creates a profile containing information on the renter including financial information (e.g., salary, credit score, employer name) at 506.

5. The prospective tenant can then visit a page on the system website providing information on the rental unit, including an Offer Board, which provides a live listing of offer activity for the rental unit at 508. In accordance with one or more embodiments, the offer activity includes information on (1) how many other offers have been made and (2) the price of each offer. FIG. 2 is a screenshot of an exemplary Offer Board page 200 showing an Offer Board 202. In an alternate embodiment, only the number of other offers made is shown to the prospective tenant. In a further alternate embodiment, no offer activity is shown to the prospective tenant.

6. If the prospective tenant decides to make an offer, he or she is directed through a confirmation page that has 2 parts: (1) a mini profile confirming that the tenant's financial details as previously filled out, and (2) a section enabling the tenant to optionally upload the real estate professional's formal application at 510 with his or her offer. By way of example, FIG. 3 illustrates a webpage 300 on which the renter can create a profile. In an alternate embodiment, the prospective tenant does not provide profile information, but only provides a rental application.

7. The prospective tenant also enters the offer amount (e.g., $2,500 per month) 302 the tenant is willing to pay for the unit at 512.

8. The prospective tenant can then be returned to the Offer Board 202 to view his or her offer as part of a complete set of offers for that unit at 514.

9. The prospective tenant can elect to be notified if and when anyone else makes an offer on that unit. The prospective tenant can, if desired, return to the Offer Board to change his or her offer upward, as many times as desired, as long as there is time left to make an offer at 516.

10. Once the real estate professional has decided which tenant's offer and application to accept at 518, all the tenants on the Offer Board 202 are notified of the decision.

11. If the tenant's offer/application is accepted, the tenant is either (1) screened, credit/criminal-checked by the system using software on the Offer Board or (2) screened, credit/criminal checked using the real estate professional's preferred method of running these checks at 520.

12. If the selected prospective tenant's screening is satisfactory, he or she is so notified at 522. If the prospective tenant is not put forward to the lease, he or she is informed of the decision, and the system can identify and suggest other similar units that may interest the tenant.

FIG. 6 illustrates an exemplary process flow involving use of the system 100 by a real estate professional.

1. The real estate professional creates a listing on the offer system for a particular real estate rental unit at 600. The listing can be advertised on various websites including, e.g., marketing websites such as Craigslist.

2. The real estate professional sets the list or guide price (e.g., $2,500 rent per month) for the unit at 602.

3. The real estate professional sets the duration of the Offer Board (e.g., for 48 hours starting 8 pm Sunday evening) at 604.

4. The real estate professional decides whether or not to accept (1) offers and applications or just (2) applications through the Offer Board at 606. Option (1) allows prospective tenants to make numeric offers of rent per month while option (2) collects their applications without showing price to other renters.

5. The real estate professional shows the unit to potential renters and instructs interested renters to go to the URL for the unit's Offer Board once the window has opened at 608.

6. The real estate professional watches his or her Offer Board dashboard as the offers come in for the property at 610. FIG. 4 illustrates one example of an Offer Board dashboard 400.

7. The real estate professional starts communicating with the renters either during the Offer Board window, or after it closes at 612.

8. The real estate professional reviews all renters' financial details and metrics (e.g., an income-to-rent ratio) calculated by the Dashboard and scores (e.g., credit ratings) at 614.

9. The real estate professional makes a decision on which renter to put forward for credit/criminal checks at 616.

10. The real estate professional either uses the Offer Board's software and APIs to perform these checks, or their own preferred software at 618.

11. The real estate professional makes a decision to accept a renter and so notifies the renter at 620.

12. The real estate professional informs other renters of the decision at 622.

Thus, in some embodiments, the real estate rental offer system exposes rental pricing and offer information transparently to prospective tenants interested in a rental unit. Renters accordingly know how many other potential tenants (if any) are also concurrently making offers on the unit. Renters can use a software platform on web or mobile to change the price of their offer, not only in relation to the list price of the unit, but also in response to what other renters are offering. Although this is technically not an auction, because the real estate professional will ultimately select the renter as a function of offer and the financial viability, the system provides an element of dynamic pricing. Renters can offer exactly list price (e.g., $2,500 rent per month), below list price (e.g., $2,400) or above list price (e.g., $2,600). The ‘price per month’ field (or per annum) is entirely malleable at the discretion of the tenant.

Real estate professionals can use a single dashboard on web or mobile (or elsewhere) to cross compare all the offers that have been made in a transparent fashion.

Real estate professionals can use the system to help them optimize price. Because price is a malleable field for renters (i.e., they can offer list price, below list price, or above list price), real estate professionals can see a delta on the price they receive through using the Offer Board. This price may be higher than list price, indicating to the real estate professional that the unit was underpriced, but nevertheless optimized by the system. Real estate professionals can cross-compare the offers made in this transparent fashion, and then use system's software to credit, criminal, and background check selected tenants.

The processes of the real estate rental offer system described above may be implemented in software, hardware, firmware, or any combination thereof. The processes are preferably implemented in one or more computer programs executing on a programmable computer (which can be part of the server computer system) including at least one processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer implemented method for conducting real estate rental transactions, comprising:
(a) providing on a server computer system an online listing for a real estate rental, said online listing being accessible by client devices operated by prospective tenants over a communications network, said online listing providing information on a real estate property to be rented;
(b) receiving, at the server computer system, an offer and a rental application for the real estate rental from each of a plurality of prospective tenants, each offer indicating a rent amount the prospective tenant is willing to pay for the real estate rental;
(c) providing a live online offer board for the real estate rental on the server computer system accessible by the client devices operated by the prospective tenants, said live online offer board displaying the rent amount of each offer received for the rental property or the total number of offers received for the rental property, said live online offer board being dynamically updated with each new offer received by the server computer system from prospective tenants;
(d) selecting a prospective tenant whose offer is to be accepted from the plurality of prospective tenants based at least in part on the offer and the rental application of the prospective tenant; and
(e) notifying the prospective tenant whose offer is to be accepted.

2. The method of claim 1, further comprising enabling prospective tenants who have previously placed offers to increase their offers, and dynamically updating the live online offer board to indicate the rent amount of each increased offer received by the server computer system.

3. The method of claim 1, wherein the online listing includes an initial guide price set by a real estate professional for the real estate rental.

4. The method of claim 1, wherein the online listing specifies a fixed time period only during which offers can be accepted for the real estate rental.

5. The method of claim 1, further comprising providing an online offer board dashboard for the real estate rental on the server computer system accessible by client devices operated by one or more real estate professionals, said online offer board dashboard providing access to offers and rental applications received for the real estate rental from prospective tenants and being dynamically updated as new offers and applications are received.

6. The method of claim 5, wherein the online offer board dashboard provides access to financial information and metrics derived from the rental application of each of the prospective tenants who have made an offer on the real estate rental.

7. The method of claim 1, further comprising obtaining background check information for one or more prospective tenants who have made an offer on the real estate rental.

8. A computer system, comprising:
at least one processor;
memory associated with the at least one processor; and
a program supported in the memory for conducting real estate rental transactions, the program containing a plurality of instructions which, when executed by the at least one processor, cause the at least one processor to:
(a) provide an online listing for a real estate rental, said online listing being accessible by client devices operated by prospective tenants over a communications network, said online listing providing information on a real estate property to be rented;
(b) receive an offer and a rental application for the real estate rental from each of a plurality of prospective tenants, each offer indicating a rent amount the prospective tenant is willing to pay for the real estate rental; and
(c) provide a live online offer board for the real estate rental accessible by the client devices operated by the prospective tenants, said live online offer board displaying the rent amount of each offer received for the rental property or the total number of offers received for the rental property, said live online offer board being dynamically updated with each new offer received by the server computer system from prospective tenants.

9. The system of claim 8, wherein the program further comprises instructions that cause the at least one processor to receive increased offers from prospective tenants who have previously placed offers, and dynamically update the live online offer board to indicate the rent amount of each increased offer received.

10. The system of claim 8, wherein the online listing includes an initial guide price set by a real estate professional for the real estate rental.

11. The system of claim 8, wherein the online listing specifies a fixed time period only during which offers can be accepted for the real estate rental.

12. The system of claim 8, wherein the program further comprises instructions that cause the at least one processor to provide an online offer board dashboard for the real estate rental accessible by client devices operated by one or more real estate professionals, said online offer board dashboard providing access to offers and rental applications received for the real estate rental from prospective tenants and being dynamically updated as new offers and applications are received.

13. The system of claim 12, wherein the online offer board dashboard provides access to financial information and metrics derived from the rental application of each of the prospective tenants who have made an offer on the real estate rental.

14. The system of claim 8, wherein the program further comprises instructions that cause the at least one processor to obtain background check information for one or more prospective tenants who have made an offer on the real estate rental.
